(19) United States
(12) Patent Application Publication
(10) Pub. No.: US 2014/0036457 A1
(43) Pub. Date: Feb. 6, 2014

(54) ARRANGEMENT HAVING BUSBARS

(71) Applicant: Carl Freudenberg KG, Weinheim (DE)

(72) Inventors: Wulf Bramesfeld, Wuppertal (DE); Martin Pohlke, Berlin (DE); Uwe Zedler, Berlin (DE); Peter Fischer, Wipperfuerth (DE)

(73) Assignee: Carl Freudenberg KG, Weinheim (DE)

(21) Appl. No.: 13/956,468

(22) Filed: Aug. 1, 2013

(30) Foreign Application Priority Data
Aug. 3, 2012 (DE) 10 2012 015 215

(51) Int. Cl. H02G 5/02

(52) U.S. Cl. CPC H02G 5/025
USPC 361/749; 174/255

(57) ABSTRACT

An arrangement includes at least one flexible circuit carrier having at least one conducting track. At least one busbar forms a composite with the flexible circuit carrier. The conducting track is welded to the busbar.

### CROSS-REFERENCE TO PRIOR APPLICATION

Priority is claimed to German Patent Application No. DE 10 2012 015 215.9, filed on Aug. 3, 2012, the entire disclosure of which is hereby incorporated by reference herein.

### FIELD

The invention relates to an arrangement comprising at least one busbar which forms a composite with at least one flexible circuit carrier that has at least one conducting track.

### BACKGROUND

DE 31 37 117 A1 discloses an arrangement in which a busbar forms a composite with at least one connecting wire. A clamping screw is provided to produce the composite.

The previously known arrangements are expensive to produce.

### SUMMARY

In an embodiment, the present invention provides an arrangement which includes at least one flexible circuit carrier having at least one conducting track. At least one busbar forms a composite with the flexible circuit carrier. The conducting track is welded to the busbar.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of an arrangement comprising a composite consisting of a busbar and a flexible circuit carrier;

FIG. 2 shows a rear view of the arrangement in FIG. 1;

FIG. 3 shows another arrangement having a plurality of busbars; and

FIG. 4 shows a rear view of the arrangement in FIG. 3, in which the flexible circuit carrier is provided with a carrier film for strength.

### DETAILED DESCRIPTION

According to an embodiment of the invention, it is recognized that by directly connecting circuit carriers to busbars it is possible to connect virtually any region of the circuit carriers to other components and/or assemblies. According to an embodiment of the invention, contact points are mechanically strengthened and supported against loads by means of a composite film. Owing to the composite-type arrangement, which can be produced by ultrasonic welding, virtually any point of the circuit carriers can be contacted directly electrically and/or mechanically in a space-saving manner with a partner to be connected. In this arrangement, contact parts can be omitted. Crimp connections having welding crimps, which often cannot be used on account of space issues, are avoided. In addition, the composite mechanically secures and strengthens the contact points, thereby improving the load resistance of the contact points. This saves on additional components, more particularly contact parts, and cuts procedural costs. In an embodiment, the invention therefore reduces material and procedural costs

The conducting track could be ultrasonically welded to the busbar. Ultrasonic welding makes it possible for very precisely defined regions to be heated selectively. For this purpose, the conducting track is stripped of film on the rear side.

The busbar could be laminated in between two circuit carriers. In this manner a particularly strong composite is achieved.

A carrier film could rest on the flexible circuit carrier. This design measure strengthens the arrangement.

The flexible circuit carrier described here is preferably constructed as a planar element having conducting tracks and/or electrical circuits on at least one film or between two films.

An assembly having passive electronic components could be provided, which components are contacted via soldered joints with the circuit carrier. A composite may carry passive electronic components, such as fuses and temperature sensors, which are contacted via soldered joints with the circuit carrier.

The arrangement described here can be used in mechatronic assemblies for battery applications. Conceivable are all uses in film technology in which films are electrically and/or mechanically contacted with other components and/or assemblies.

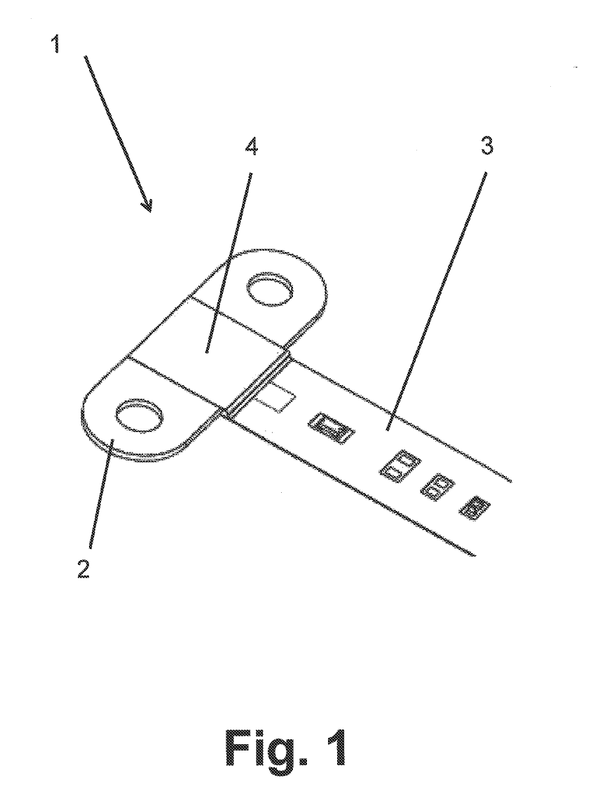

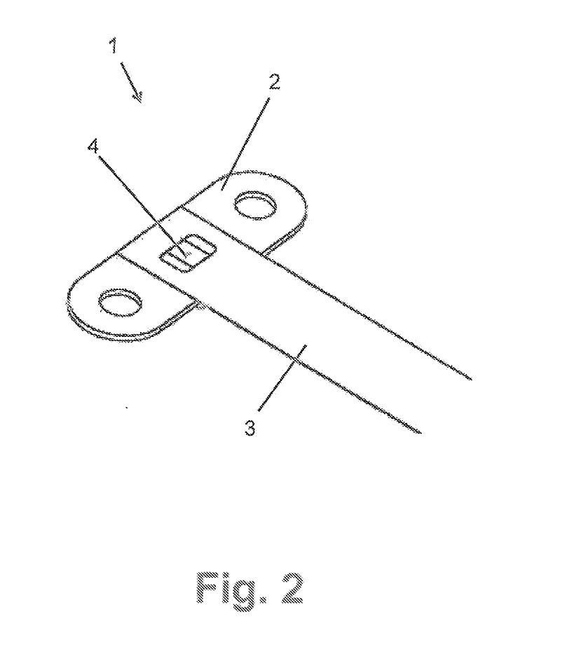

FIGS. 1 and 2 show an arrangement 1 comprising at least one busbar 2 which forms a composite with at least one flexible circuit carrier 3, the flexible circuit carrier 3 having at least one conducting track 4.

The conducting track 4 is welded to the busbar 2. In one embodiment, the conducting track 4 is ultrasonically welded to the busbar 2.

The busbar 2 is made of metal. The conducting track 4 is made of copper and has been stripped of film on the rear side using a method for removing material, such as using lasers, to allow access for the ultrasonic welding.

The flexible circuit carrier 3 comprises at least one film and conducting tracks 4.

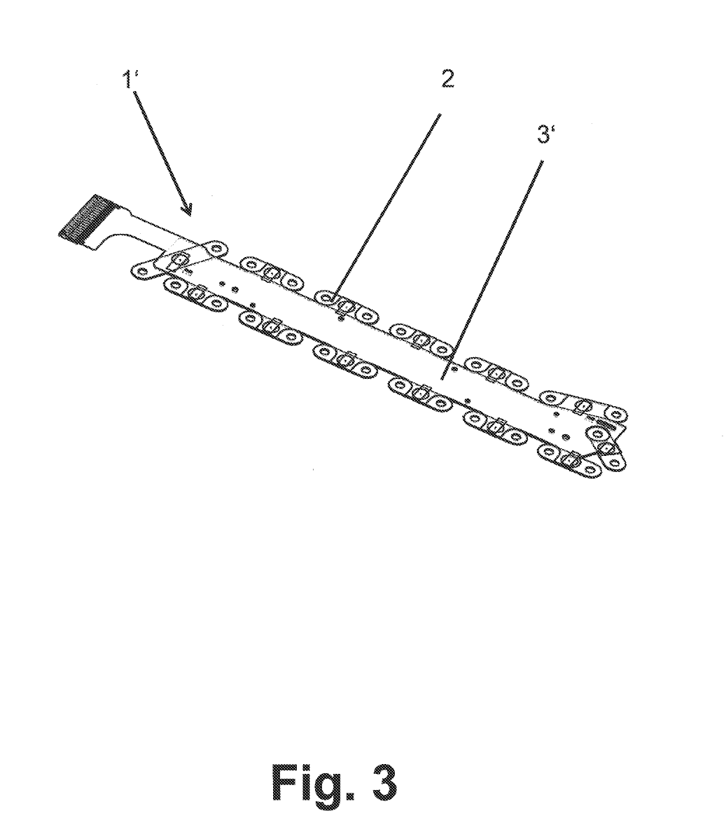

FIG. 3 shows an arrangement 1′ having a plurality of metal busbars 2 which forms a composite with a circuit carrier 3′ having a plurality of conducting tracks 4.

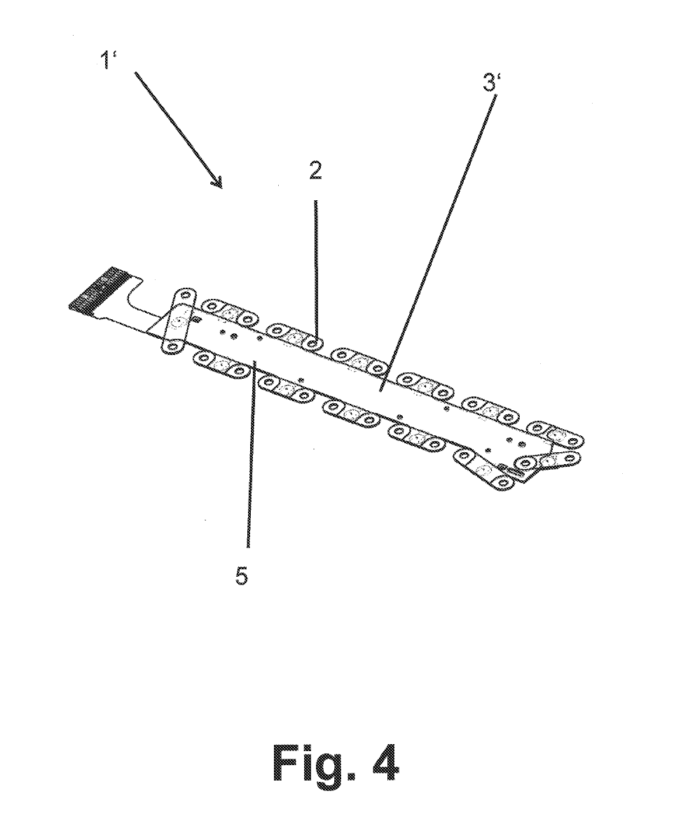

FIG. 4 shows the arrangement 1′ in FIG. 3 having a plurality of metal busbars 2 which forms a composite with a circuit carrier 3′ having a plurality of conducting tracks 4. A carrier film 5 rests on the flexible circuit carrier 3′.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

What is claimed is:

1. An arrangement comprising:
at least one flexible circuit carrier having at least one conducting track;
at least one busbar forming a composite with the flexible circuit carrier, wherein the conducting track is welded to the busbar.

2. The arrangement according to claim 1, wherein the conducting track is ultrasonically welded to the busbar.

3. The arrangement according to claim 1, wherein the busbar is laminated in between two of the circuit carriers.

4. The arrangement according to claim 1, further comprising a carrier film resting on the circuit carrier.

5. The arrangement according to claim 1, further comprising an assembly having passive electronic components that are contacted via soldered joints with the circuit carrier.
